(19) United States
(12) Patent Application Publication
(10) Pub. No.: US 2002/0023975 A1
(43) Pub. Date: Feb. 28, 2002

(54) Spraying nozzle for generating a spray fan and method of spraying

(76) Inventors: Lothar Bendig, Pfullingen (DE); Michael Lipthal, Ditzingen (DE); Lars Vater, Plierzhausen (DE)

Correspondence Address: CROWELL & MORING LLP, INTELLECTUAL PROPERTY GROUP, P.O. BOX 14300, WASHINGTON, DC, 20044-4300, US

(21) Appl. No.: 09/900,709

(22) Filed: Jul. 9, 2001

(30) Foreign Application Priority Data
Jul. 7, 2000 (DE) 100 33 190.4
Aug. 22, 2000 (DE) 100 41 119.3

(51) Int. Cl. B05B 1/26

(52) U.S. Cl. 239/504; 239/513

(57) ABSTRACT

A spraying nozzle is described which is provided with an outlet opening for forming a liquid jet and with an impact surface which is arranged behind this outlet opening in the flow direction, for generating a spray fan. The impact surface is constructed as a convexly curved surface of a tongue extending from the outlet opening into the liquid jet, the impact surface also being set at a setting angle α with respect to the axis of the liquid jet emerging from the outlet opening.

### BACKGROUND AND SUMMARY OF THE INVENTION

This application claims the priority of German Patent Applications 100 33 190.4, filed Jul 7, 2000 and 100 41 119.3, filed Aug. 22, 2000, the disclosures of which are expressly incorporated by reference herein.

The invention relates to a spraying nozzle having an outlet opening for forming a liquid jet and having an impact surface arranged behind the outlet opening in the flow direction, for generating a spray fan.

Flat-jet nozzles are known which spray a liquid jet onto a flat impact surface in order to generate an essentially flat spray fan. However, fields of application are known in which approximately circular-cylindrically constructed embodiments are to be covered with a circular or circular-segment shaped liquid shield for shielding against a detection by means of infrared systems. For this purpose, the known flat-jet nozzles are not necessarily suitable because they can be used to implement only polygonal-course-shaped spray images by the use of several nozzles. Such flat-jet nozzles also have strong marginal jets and therefore a very non-uniform distribution of the liquid over the width of its fan.

It is therefore an object of the present invention to construct a spraying nozzle of the initially mentioned type such that an approximately circular or circular-segment-shaped spray fan can be generated.

In order to achieve this object, it is provided in the case of a spraying nozzle of the initially mentioned type that the impact surface is constructed as a convexly curved surface of a tongue extending from the outlet opening into the liquid jet.

This further development has the result that the liquid impacts on the convexly curved impact surface and therefore assumes its curvature. This results in a semicircular liquid mist with a uniform distribution of the liquid.

As a further development of the invention, the impact surface is set up at a setting angle with respect to the axis of the liquid jet emerging from the outlet opening. This setting angle determines the jet angle and the spraying width. In this case, the width of the tongue can widen in the direction of the liquid jet so that a fan-shaped division of the spraying jet occurs which is particularly good. In this case, the setting angle and the convex curvature are in each case selected such that the desired shape of the semicircular liquid haze is achieved.

Other objects, advantages and novel features of the present invention will become apparent from the following detailed description of the invention when considered in conjunction with the accompanying drawings.

### BRIEF DESCRIPTION OF THE DRAWINGS

FIG. 1 is a perspective representation of a spraying nozzle according to the invention;

FIG. 2 is a longitudinal sectional center view of the nozzle according to FIG. 1;

FIG. 3 is a top view of an operating spraying nozzle according to FIG. 1; and

FIG. 4 is a view of the operating spraying nozzle according to FIG. 3 viewed in the direction of the arrow IV of FIG. 3.

### DETAILED DESCRIPTION OF THE DRAWINGS

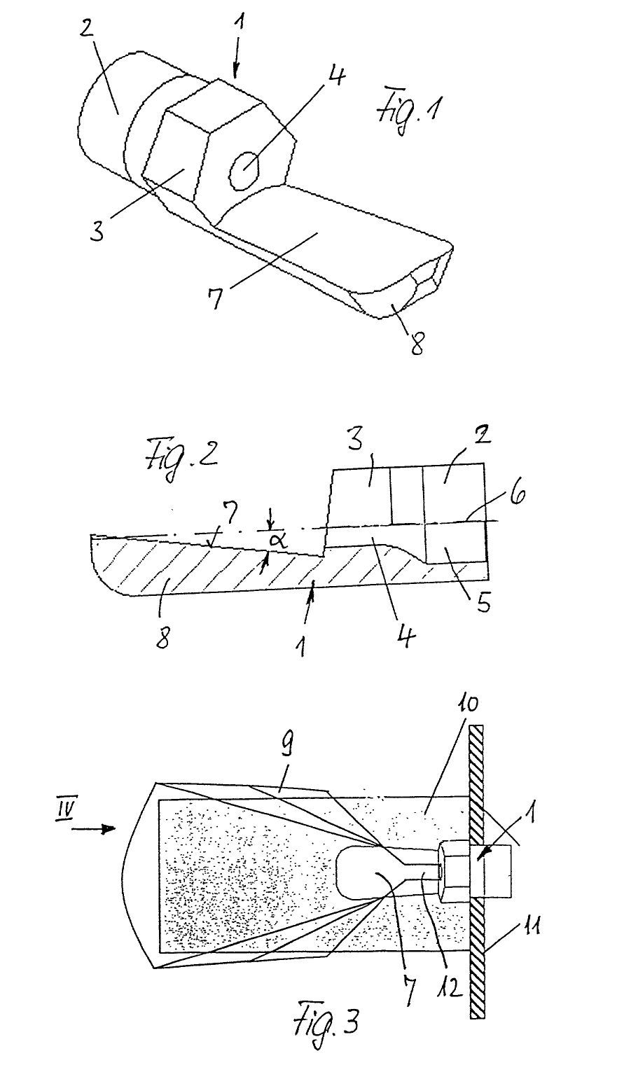

FIG. 1 shows that the new spraying nozzle 1 is provided with a connection piece 2 for feeding a liquid into the interior of a housing 3. This housing 3 has an outlet opening 4 which extends from the interior chamber 5 (FIG. 2) to the outside. In this case, the outlet opening 4 is situated at the end of a duct which extends in a narrowing manner out of the chamber 5 and whose axis 6 defines the direction of the emerging liquid jet.

An impact surface 7 in the form of a convexly curved surface of a tongue 8 extending from the outlet opening 4 into the liquid jet is provided in the flow direction behind the outlet opening 4. It can easily be recognized in FIG. 2 that this impact surface 7 is set at a setting angle α with the respect to the axis 6 of the emerging liquid jet.

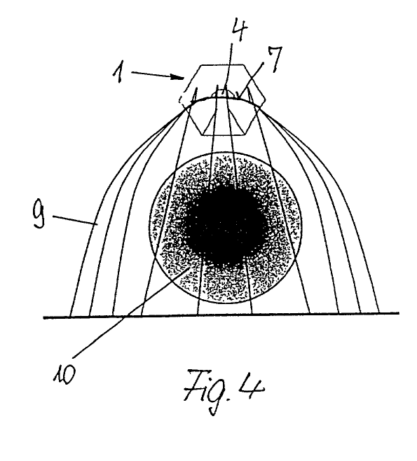

The illustrated arrangement of the impact surface with respect to the—not shown—liquid jet clearly illustrates that the impact surface 7 projects into the forming liquid jet. The liquid, which impacts on the convexly curved impact surface 7, is changed to a fan jet shape corresponding to the radius of the convex impact surface 7. The shape of this fan is approximately semicircular, and this fan 9 is clearly shown in FIGS. 3 and 4.

As also illustrated in FIGS. 3 and 4, it becomes possible by means of such a spraying nozzle to completely cover circular-cylindrical embodiments 10, for example, gas or liquid flows, by means of a liquid fan. Such applications become necessary, for example, when covering exhaust plumes on boats when an infrared detection of their exhaust plumes, which have a higher temperature, is to be prevented.

FIG. 3 also shows that the spraying nozzle 1 can be installed into a wall 11 in a manner known per se. FIG. 3 also illustrates that the liquid jet 12, which at first exits in an approximately circular-cylindrical shape, is widened when impacting on the impact surface 7 and will then, according to FIG. 4, assume the curvature of the convex impact surface 7.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed:

1. Spraying nozzle having an outlet opening for forming a liquid jet and having an impact surface arranged behind the outlet opening in the flow direction, for generating a spray fan,
wherein the impact surface is constructed as a convexly curved surface of a tongue extending from the outlet opening into the liquid jet.

2. Spraying nozzle according to claim 1,
wherein the impact surface is set at a setting angle with respect to the axis of the liquid jet emerging from the outlet opening.

3. Spraying nozzle according to claim 1,
wherein the width of the tongue increases in the direction of the liquid jet.

4. Spraying nozzle according to claim 2,
wherein the setting angle and the convex curvature of the impact surface are selected according to the desired shape of the semicircular liquid haze to be formed.

5. Spraying nozzle comprising:
a connection piece,
a housing having a duct connected at one end to the connection piece and having an outlet opening at an opposite end, and
a tongue connected to the housing and forming an impact surface downstream of the outlet opening, said impact surface projecting into a jet of fluid from the outlet opening,
wherein said impact surface is convexly curved to deflect said jet into an approximately semicircular fan jet shape during operation of the nozzle with high pressure fluid supply through the connection piece and housing outlet opening.

6. Spraying nozzle according to claim 5, wherein said outlet opening is circular such that the fluid exits in a cylindrical shape and impacts the impact surface at a location downstream of the outlet opening.

7. Spraying nozzle according to claim 6, wherein said duct narrows in a downstream direction.

8. A method of spraying a fluid comprising:
supplying high pressure fluid to a spraying nozzle housing which has a duct with an outlet opening; and
deflecting the fluid exiting from the outlet opening to form a curved spray pattern by impacting said fluid against a tongue disposed downstream of the outlet opening, which tongue has a convexly curved impact surface.

9. A method according to claim 8, wherein said outlet opening is circular such that the fluid exits in a cylindrical shape and impacts the impact surface at a location downstream of the outlet opening.

10. A method according to claim 9, wherein said duct narrows in a downstream direction.
